(19) United States
(12) Patent Application Publication
(10) Pub. No.: US 2021/0304159 A1
(43) Pub. Date: Sep. 30, 2021

(54) SERVER, COMPUTER-READABLE RECORDING MEDIUM AND SYSTEM

(71) Applicant: TOYOTA JIDOSHA KABUSHIKI KAISHA, Toyota-shi (JP)

(72) Inventors: Kenichi YAMADA, Nisshin-shi (JP); Tadaaki SAKAMOTO, Tokyo (JP); Yuma HAYASHIDA, Tokyo (JP); Masatoshi ISHIZUKA, Tokyo (JP); Mika TAKAKI, Tokyo (JP); Takuya KAGA, Mitaka-shi (JP); Tetsuya SAKAI, Tokyo (JP); Tsukasa KARASAWA, Nagoya-shi (JP)

(73) Assignee: TOYOTA JIDOSHA KABUSHIKI KAISHA, Toyota-shi (JP)

(21) Appl. No.: 17/204,252

(22) Filed: Mar. 17, 2021

(30) Foreign Application Priority Data
Mar. 26, 2020 (JP) 2020-056866

(51) Int. Cl. G06Q 20/08; G06Q 20/10; G06Q 20/02

(52) U.S. Cl. CPC G06Q 20/0855; G06Q 20/027; G06Q 20/108

(57) ABSTRACT

A server includes a processor having hardware. The processor is configured to authenticate, upon acquiring from a first device a gift request for electronic money and a message for a second device, the gift request, execute a gifting process when the authentication is successful, and output gift details and the message to the second device.

### CROSS-REFERENCE TO RELATED APPLICATION

This application claims priority to Japanese Patent Application No. 2020-056866 filed on Mar. 26, 2020, incorporated herein by reference in its entirety.

### BACKGROUND

### 1. Technical Field

The present disclosure relates to a server, a computer-readable recording medium, and a system.

### 2. Description of Related Art

A system for sending electronic money using an information processing terminal is already well-known (for example, see Japanese Unexamined Patent Application No. 2012-94061).

### SUMMARY

Even when transferring electronic money, people want to show their feelings and sentiments.

The present disclosure provides a server, a computer-readable recording medium, and a system capable of enabling a remitter to show his/her feelings and sentiments even when transferring electronic money.

A server according to the present disclosure includes a processor having hardware. The processor is configured to, upon acquiring from a first device a gift request for electronic money and a message for a second device, authenticate the gift request, execute a gifting process when the authentication is successful, and output gift details and the message to the second device.

A computer-readable recording medium according to the present disclosure causes a processor having hardware to, upon acquiring from a first device a gift request for electronic money and a message for a second device, authenticate the gift request, execute a gifting process when the authentication is successful, and output gift details and the message to the second device.

A system according to the present disclosure includes a first device which is provided with a first processor having hardware, a second device which is provided with a second processor having hardware, and a server which is provided with a third processor having hardware. The first processor is configured to output, to the server, a gift request for electronic money and a message for the second device. The third processor is configured to, upon acquiring the gift request of the electronic money and the message, authenticate the gift request, execute a gifting process when the authentication is successful, and output gift details and the message to the second device.

With the present disclosure, a remitter can show his/her feelings and sentiments even when transferring electronic money.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram illustrating a functional configuration of a system according to a first embodiment of the present disclosure;

FIG. 2 is a sequence diagram illustrating an outline of a process executed by the system according to the first embodiment of the present disclosure;

FIG. 3 is a diagram schematically illustrating an entire configuration of a system according to a second embodiment of the present disclosure;

FIG. 4 is a block diagram illustrating a functional configuration of the system according to the second embodiment of the present disclosure; and

FIG. 5 is a sequence diagram illustrating an outline of a process executed by the system according to the second embodiment of the present disclosure.

### DETAILED DESCRIPTION OF EMBODIMENTS

Hereinafter, modes for carrying out the present disclosure (hereinafter, referred to as “embodiments”) will be described referring to the accompanying drawings.

### First Embodiment

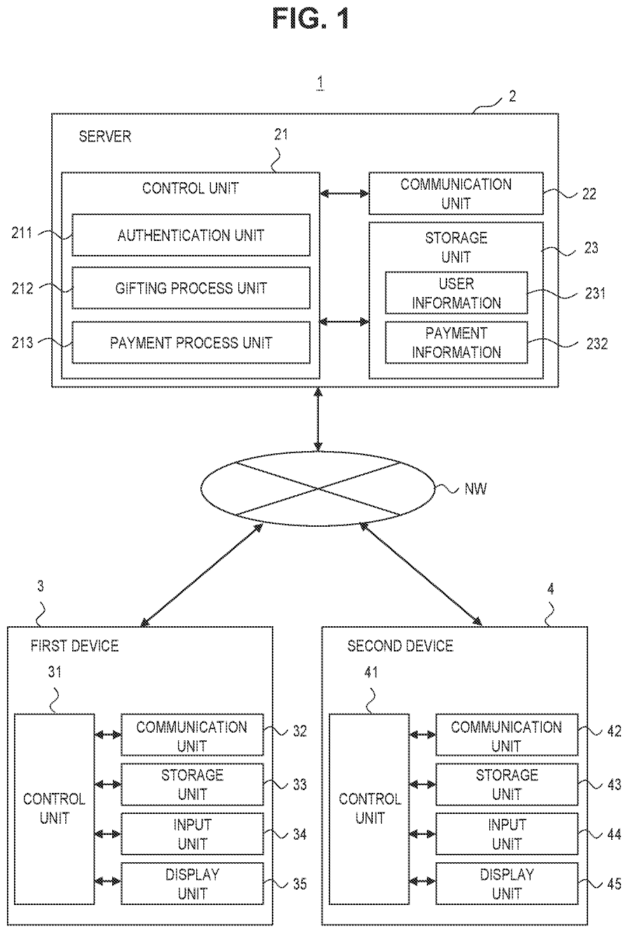

FIG. 1 is a block diagram illustrating a functional configuration of a system according to a first embodiment of the present disclosure. A system 1 shown in the drawing includes a server 2, a first device 3, and a second device 4.

The server 2, the first device 3, and the second device 4 are configured to be able to communicate with each other via a network NW. The network NW is configured by, for example, an internet line network or a mobile phone line network, in which wired and wireless networks are appropriately combined.

The server 2 is provided in a financial institution (for example, banks, credit unions, credit associations and labor unions), or a credit card company, and is a server for managing accounts of the financial institution or credit cards. The server 2 includes a control unit (third processor) 21, a communication unit 22, and a storage unit 23.

The control unit 21 comprehensively controls operations of the server 2. The control unit 21 includes an authentication unit 211, a gifting process unit 212, and a payment process unit 213. The authentication unit 211, upon receiving and acquiring (hereinafter simply referred to as “receiving”) from the first device 3 a gift request for electronic money and a message for the second device 4, authenticates the gift request. Furthermore, the authentication unit 211, upon receiving a payment request from the second device 4, authenticates the payment request. The gifting process unit 212 executes a gifting process in a case where the authentication unit 211 has successfully authenticated the gift request. The payment process unit 213 executes a payment process in a case where the authentication unit 211 has successfully authenticated the payment request.

The control unit 21 is provided with, in particular, a processor configured by, for example, a central processing unit (CPU), a digital signal processor (DSP) or a field-programmable gate array (FPGA), and a memory (main storage unit), for example, a random access memory (RAM) or a read only memory (ROM).

The control unit 21 loads a program stored in the storage unit 23 into a working area of the main storage unit and executes such a program. Each component of the server 2 is controlled by executing various programs.

The communication unit 22 is configured by, for example, a LAN (local area network) interface board or a wireless communication circuit for wireless communication. The communication unit 22 is connected to the network NW. The communication unit 22 establishes a communication link between the first device 3 and the second device 4 by connecting to the network NW as controlled by the control unit 21.

The storage unit 23 is configured by a recording medium such as an EPROM (erasable programmable ROM), an HDD (hard disk drive), a removable medium, or the like. Examples of the removable medium include a disc recording medium such as a USB (universal serial bus) memory, a CD (compact disc), a DVD (digital versatile disc), and a BD (Blu-ray (registered trademark) disc). The storage unit 23 stores an operating system (OS), various programs, various tables, various databases, and the like.

The storage unit 23 stores user information 231 and payment information 232 for each registered user. The user information 231 includes a user's account information and credit card information. The account information may include, for example, the user's name, account number, account balance, transaction history (list of deposits and withdrawals), and the like. The credit card information may include, for example, the user's name, credit card number, credit card expiration date, credit limit, card usage transaction history, and the like. The payment information 232 includes a user ID, a payment method used for payment (for example, e-money payment (contactless payment), scan-to-pay, QR code payment, etc.), payment history, and the like.

The server 2 having the functional configuration stated above is implemented by a computer such as a workstation, a personal computer, or the like.

The first device 3 includes a control unit (first processor) 31, a communication unit 32, a storage unit 33, an input unit 34, and a display unit 35. The control unit 31, the communication unit 32, and the storage unit 33 are physically configured by using the same hardware as the control unit 21, the communication unit 22, and the storage unit 23, respectively. The input unit 34 is configured using a touchscreen. The input unit 34 may have a microphone for voice input. The display unit 35 has a display made of liquid crystal or organic EL (electroluminescence) on its surface. A touchscreen forming the input unit 34 is provided on a surface of the display. Examples of the first device 3 include a smartphone, a mobile phone, a tablet terminal, and the like. The program to be executed by the first device 3 may be provided as an application downloadable via the network NW.

The second device 4 includes a control unit (second processor) 41, a communication unit 42, a storage unit 43, an input unit 44, and a display unit 45. A configuration of the second device 4 is similar to that of the first device 3.

As an example where the system 1 having the functional configuration stated above is used, a case is assumed in which there are two users using the first device 3 and the second device 4, respectively, and electronic money is presented as a gift from one user to the other user. When the gift is presented, the user who gives the gift inputs and transmits (hereinafter simply referred to as “transmit(s)”) a message to the user who receives the gift. Hereinafter, the user who uses the first device 3 is called a first user, and the user who uses the second device 4 is called a second user.

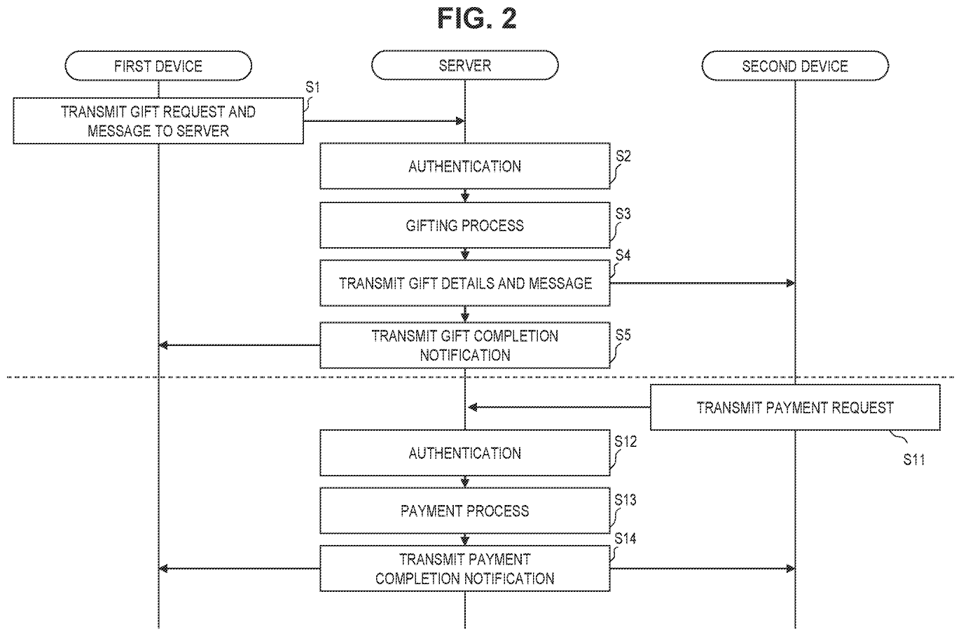

FIG. 2 is a sequence diagram illustrating an outline of a process executed by the system 1. When the input unit 34 of the first device 3 accepts a gift request and a message, which are input for the second device 4, the control unit 31 transmits the gift request and the message to the server 2 via the communication unit 32 (step S1). For example, when the relationship of the first user and the second user is parent and child, the first user, who is a parent, inputs, as the gift request, a deposit amount of the electronic money, a user who will receive the gift, and information that restricts use of the electronic money and also inputs a message saying, for example, “Happy Birthday!” to the second user, who is his/her child. The information that restricts the use of the electronic money may be, for example, restrictions on items (books, clothing, etc.) that can be purchased with the electronic money, or restrictions on stores at which or periods in which the electronic money can be used.

The authentication unit 211 of the server 2, which receives the gift request of the electronic money and the message, performs authentication based on the gift request (step S2). The authentication unit 211 determines whether or not the second device 4 which will receive the gift is legitimate, or whether the deposit amount specified by the first user is available, referring to the user information 231.

When the authentication unit 211 has successfully authenticated, the gifting process unit 212 executes a gifting process in response to the gift request (step S3). In particular, the gifting process unit 212 updates the user information 231 by depositing the amount of electronic money corresponding to the gift request into an account of the second device 4. In a case where the authentication unit 211 fails to authenticate, the control unit 21 transmits, to the first device 3, a message notifying that the authentication has failed via the communication unit 22.

After step S3, the control unit 21 transmits gift details and the message received in step S2 to the second device 4 via the communication unit 22 (step S4). The gift details may include, for example, the deposit amount of the electronic money and information on the user who sends the gift.

The control unit 21 transmits to the first device 3 a notification that the gifting process is completed via the communication unit 22 (step S5). Furthermore, a processing order of steps S4 and S5 is not specified, and those two steps may be carried out in parallel.

According to steps S1 to S5, stated above, the server 2 transmits, to the second device 4, the gift details and the message made by the first user, thus the second user can also receive the sentiments for the electronic money of the first user.

Referring to FIG. 2, an outline of a process when the second user uses the electronic money presented as the gift by using the second device 4 will be described. In FIG. 2, a broken line drawn between step S5 and step S11 indicates that the processes before and after such a line are temporally separated.

When the input unit 44 of the second device 4 accepts a payment request using the electronic money presented as the gift, the control unit 41 transmits the payment request to the server 2 via the communication unit 42 (step S11).

The authentication unit 211 of the server 2, which receives the payment request, performs authentication based on the payment request (step S12). The authentication unit 211 determines whether the second device 4 is legitimate and whether the payment amount can be paid, by referring to the user information 231.

When the authentication unit 211 has successfully authenticated, the payment process unit 213 executes a payment process in response to the payment request and updates the user information 231 (step S13). For example, the payment process herein may include, for example, in a case where the user attempts to buy an item, a process of depositing the electronic money corresponding to a price of the item into a server managed by a seller of the item. In a case where the authentication unit 211 fails to authenticate, the control unit 21 transmits, to the second device 4, a message notifying that the authentication has failed. For example, in a case where the electronic money presented as the gift is permitted only for buying books but a payment request for clothing is received from the second device 4, the authentication unit 211 determines that the authentication has failed.

After step S13, the control unit 21 transmits, to the first device 3 and the second device 4, a payment completion notification via the communication unit 22 (step S14).

When the second user uses the second device 4 to transmit a payment request, the second user may input a message to the first user (for example, a message saying “Thank you.”) In this case, in step S14, the control unit 21 transmits, to the first device 3, the message together with the notification that the payment is completed.

According to the first embodiment of the present disclosure stated above, upon acquiring from the first device the gift request of the electronic money and the message for the second device, the gifting process is executed after the authentication, and then the gift details and message are sent to the second device. Consequently, the second user can receive the message from the first user (who sends the money), thus the second user can feel the feelings and sentiments toward him/her even when receiving electronic money.

According to the first embodiment, in a case of receiving the payment request for the electronic money from the second device, the payment process is executed after the payment request is authenticated, and the notification that the payment is completed is transmitted to the first device and the second device. Accordingly, it is possible to confirm that the payment has been made.

Further, according to the first embodiment, the gift request includes the information that restricts use of the electronic money, and the payment request is authenticated by determining whether a use of the electronic money in the payment request from the second device matches such information, thus it is possible to enable the second user to use the electronic money presented as the gift in a way intended by the first user.

### Second Embodiment

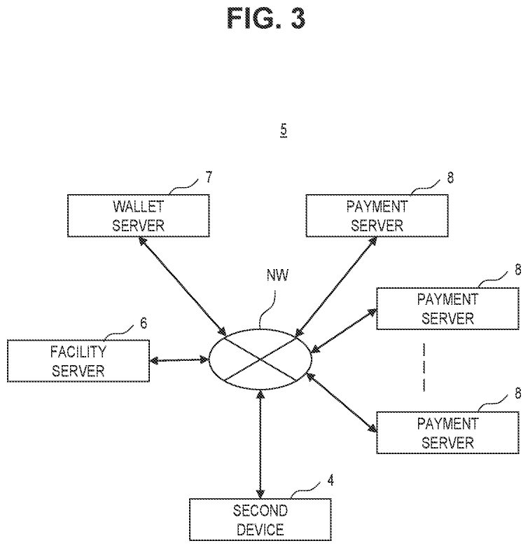

FIG. 3 is a diagram schematically illustrating an entire configuration of a system according to a second embodiment of the present disclosure. A wallet system (system) 5 shown in FIG. 3 includes a facility server (first device) 6, a second device (second device) 4, a wallet server (server) 7, and several payment servers (third device) 8. The facility server 6, the second device 4, the wallet server 7, and the payment servers 8 are configured to be able to communicate with each other via the network NW. The payment servers 8 are servers managed by different payment system providers (financial institutions or credit card companies), and accept payment requests from users via the wallet server 7. In other words, the wallet system 5 is a system that allows the user to select a payment method when paying with the electronic money.

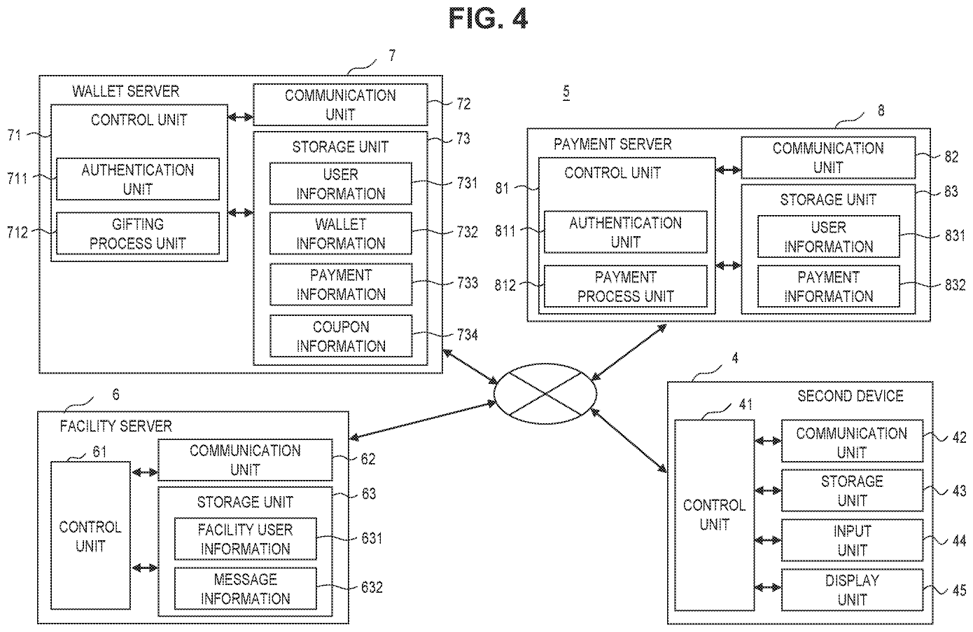

FIG. 4 is a block diagram illustrating a functional configuration of the system according to the second embodiment. Hereinafter, components having the same functions as the components described in the first embodiment will be described with the same reference numerals. Furthermore, only one payment server 8 is representatively shown in FIG. 4.

The facility server 6 is a server provided in a facility such as a medical institution, for the purpose of managing and operating the facility. The facility server 6 includes a control unit (first processor) 61, a communication unit 62, and a storage unit 63. The control unit 61, the communication unit 62, and the storage unit 63 are physically configured by using the same hardware as the control unit 21, the communication unit 22, and the storage unit 23, respectively, which are defined in the first embodiment. The facility server 6 is implemented by a computer such as a workstation, a personal computer, or the like.

The control unit 61 comprehensively controls operations of the facility server 6. The control unit 61 transmits, to the wallet server 7, a gift request for electronic money for a target facility user via the communication unit 62, by referring to facility user information 631 stored in the storage unit 63. In the second embodiment, a case where the control unit 61 requests the wallet server 7 to issue a money coupon of a predetermined amount will be described as one example of the gift request, but the gift request may be a request of monetary assistance.

The storage unit 63 includes the facility user information 631 on a registered facility user, and message information 632 to be transmitted to a receiver who receives the electronic money. The facility user information 631 includes, as information on an access destination that the facility server will access via the network NW, a user's e-mail account and information on a terminal (second device 4) owned by the user, as well as personal information such as the user's name and address. The message information 632 stores a message to be sent to the facility user corresponding to a type of the coupon.

The second device 4 is associated with the facility user. For example, in a case where the facility is a medical institution, a patient who uses the medical institution corresponds to the user.

The wallet server 7 includes a control unit (third processor) 71, a communication unit 72, and a storage unit 73. The control unit 71, the communication unit 72, and the storage unit 73 are physically configured by using the same hardware as the control unit 21, the communication unit 22, and the storage unit 23, respectively.

The control unit 71 comprehensively controls operations of the wallet server 7. The control unit 71 includes an authentication unit 711 and a gifting process unit 712. The authentication unit 711, upon receiving from the facility server 6 a gift request for electronic money and a message for the second device 4, authenticates the gift request. Furthermore, the authentication unit 711, upon receiving a payment request from the second device 4, authenticates the payment request. The gifting process unit 712 executes a gifting process in a case where the authentication unit 711 has successfully authenticated the gift request. The gift request is, specifically, a request for issuing a coupon, and the gifting process unit 712 issues, as the gifting process, a coupon that matches the gift request. In this case, information that restricts use of the coupon may be added to the coupon.

The storage unit 73 stores, in the wallet system 5, user information 731, wallet information 732, payment information 733, and coupon information 734 for each registered user.

The user information 731 is information on a user who uses the wallet system 5. Examples of the user information 731 include a user ID of a user who has previously registered to use the wallet system 5, a password, the user's name, the user's contact information (for example, address, telephone number, e-mail account), and the like. The user ID and password in the user information 731 are used when performing the authentication such as a login to the wallet server 7.

The wallet information 732 is information on a wallet of the wallet system 5. A wallet is a virtual account into which and from which electronic money can be deposited and withdrawn. The wallet information 732 may include, for example, a user ID, an electronic money balance, deposit history of electronic money, electronic money transaction history, and the like.

The payment information 733 is information on payments made in the wallet system 5. The payment information 733 includes a user ID, a payment system provider or payment method used for payment, payment history, and the like.

The coupon information 734 is information on the coupon issued in response to the gift request of the electronic money received from the facility server 6. The coupon information 734 includes information such as a type of a coupon, an amount of money equivalent to a coupon, coupon issue history for each user, and the like.

The payment server 8 is a server that is provided for each payment system provider and manages accounts of the financial institution or credit cards. The payment server 8 includes a control unit (fourth processor) 81, a communication unit 82, and a storage unit 83. The control unit 81, the communication unit 82, and the storage unit 83 are physically configured by using the same hardware as the control unit 21, the communication unit 22, and the storage unit 23, respectively.

The control unit 81 includes an authentication unit 811 and a payment process unit 812. The authentication unit 811, upon receiving a payment request from the wallet server 7, authenticates the payment request. The payment process unit 812 executes a payment process in a case where the authentication unit 811 has successfully authenticated the payment request.

The storage unit 83 stores user information 831 and payment information 832 for each registered user. The user information 831 includes account information and credit card information for each user of the wallet system 5, while the account information is information on an account registered to the payment system provider who manages the payment server 8. The payment information 832 includes a user ID, a payment method used for payment, payment history, and the like.

In the wallet system 5 having the functional configuration stated above, the facility server 6 presents the electronic money as the gift to the second device 4, which can be used for paying facility fees and is in a form of the coupon. When the facility server 6 presents the electronic money as the gift, it also sends a message encouraging the second user to use the facility.

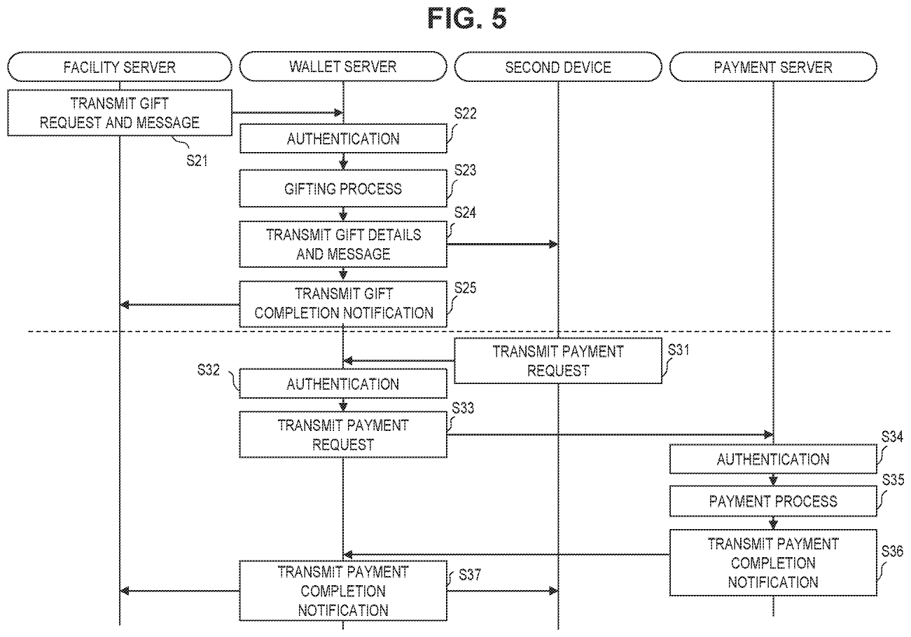

FIG. 5 is a sequence diagram illustrating an outline of a process executed by the wallet system 5. The control unit 61 transmits, to the wallet server 7, a gift request for electronic money and a message for the second device 4 via the communication unit 62 (step S221). The gift request of the electronic money includes a request for issuing a coupon, and information on the second device 4 which will receive the gift. For example, in a case where the facility is, for example, a medical institution and a coupon for a health checkup is presented as a gift, the control unit 61 sends a message saying “The day is approaching when you should have a regular health checkup. Here is a coupon for you, you can use it for your health checkup”, by referring to the message information 632.

The authentication unit 711 of the wallet server 7, which receives the gift request of the electronic money and the message, performs authentication based on the gift request (step S22). The authentication unit 711 determines whether or not the coupon is valid and whether the second device 4 which will receive the gift is legitimate.

When the authentication unit 711 has successfully authenticated, the gifting process unit 712 executes a gifting process in response to the gift request (step S23). In particular, the gifting process unit 712 issues the coupon to be transmitted to the second device 4 by referring to the coupon information 734. In a case where the authentication unit 711 fails to authenticate, the control unit 71 transmits, to the facility server 6, a message notifying that the authentication has failed via the communication unit 72.

After step S23, the control unit 71 transmits the gift details and the message received in step S22 to the second device 4 via the communication unit 72 (step S24). The gift details may include, for example, data on the issued coupon and information on the facility which sends the gift.

The control unit 71 transmits, to the facility server 6, a notification that the gifting process is completed via the communication unit 72 (step S25). Furthermore, a processing order of steps S24 and S25 is not specified, and those two steps may be carried out in parallel.

According to steps S21 to S25, stated above, the wallet server 7 transmits, to the second device 4, the gift details (coupon) and the message produced by the facility, thus the second user can recognize a value of the coupon presented as the gift.

Referring to FIG. 5, an outline of a process when the second user uses the coupon presented as the gift will be described. When the input unit 44 of the second device 4 accepts a payment request using the electronic money presented as the gift, the control unit 41 transmits the payment request to the wallet server 7 via the communication unit 42 (step S31). The payment request includes coupon data, as well as the information on the payment system provider which manages the payment server 8 that will receive the payment request.

The authentication unit 711, which receives the payment request, performs authentication based on the payment request (step S32). The authentication unit 711 determines whether or not the second device 4 is legitimate, whether the coupon is valid, whether the payment server 8 designated as a provider of a payment method is legitimate, and whether the payment amount desired can be paid.

When the authentication unit 711 has successfully authenticated, the control unit 71 transmits the payment request to the payment server 8 via the communication unit 72 (step S33). The control unit 71 generates a payment request with the amount minus the coupon value. In a case where the authentication unit 711 fails to authenticate, the control unit 71 transmits to the second device 4 a message notifying that the authentication has failed. For example, if the account balance of the second device 4 is not enough to pay the amount minus the coupon value, the authentication unit 711 determines that the authentication has failed.

The authentication unit 811 of the payment server 8, which receives the payment request, performs authentication based on the payment request (step S34). The authentication unit 811 determines whether the wallet server 7 is legitimate and whether the payment amount can be paid.

When the authentication unit 811 has successfully authenticated, the payment process unit 812 executes a payment process in response to the payment request (step S35). In a case where the authentication unit 811 fails to authenticate, the control unit 81 transmits to the wallet server 7 a message notifying that the authentication has failed.

After step S35, the control unit 81 transmits, to the wallet server 7, a notification that the payment is completed via the communication unit 82 (step S36).

The wallet server 7, which has received the notification that the payment is completed, transmits notifications that the payment is completed to the facility server 6 and the second device 4 (step S37).

Furthermore, instead of the wallet server 7 generating the payment request for the amount minus the coupon value, the payment request including the initial amount and the coupon data may be transmitted to the payment server 8, and the payment server 8 may handle the coupon to execute the payment process for the amount discounted by the coupon.

Alternatively, the facility server 6 may generate the coupon and transmit the gift request including the coupon data to the wallet server 7 together with the message.

According to the second embodiment of the present disclosure stated above, the facility (which sends the gift) can allow the facility user to recognize the value of the gift even when the gift is electronic money, as in the first embodiment. Furthermore, according to the second embodiment, it is possible to confirm that the payment has been made, and to enable the second user to use the electronic money presented as the gift as intended by the facility, as in the first embodiment.

Further, according to the second embodiment, the second user can select a payment system provider as he/she wants, thus the convenience is improved and he/she can pay as intended.

### Other Embodiments

The embodiments for carrying out the present disclosure have been described, but the present disclosure should not be limited only to the first and second embodiments. For example, a wallet server and a payment server of a different payment system provider may be added to the first embodiment.

In the second embodiment, in a case where the second user uses the facility with his/her friends, discounts for use of the facility or transportation may be provided in cooperation with transportation that can be used to visit the facility. Accordingly, it is possible to encourage the user to use the facility.

Furthermore, edge computing may be adapted to shorten a time taken to execute an arithmetic process, in which terminals that can partially execute processes of various servers are distributed in several points of a territory and terminals close to each other communicate enormous amounts of data efficiently.

Further advantageous effects and modifications can be easily appreciated by those skilled in the art. The aspects of the present disclosure are not limited to the specific details and representative embodiments illustrated and described above. Accordingly, various modifications may be made without departing from the spirit or scope of the general inventive concept as defined by the following claims and their equivalents.

What is claimed is:

1. A server comprising:
a processor having hardware,
wherein the processor is configured to:
upon acquiring from a first device a gift request for electronic money and a message for a second device, execute authentication the gift request;
execute a gifting process when the authentication is successful; and
output gift details and the message to the second device.

2. The server according to claim 1, wherein:
the gift request includes a deposit amount of the electronic money; and
the processor is configured to deposit the deposit amount into an electronic money account associated with the second device.

3. The server according to claim 1, wherein:
the gift request includes a request for issuing a coupon of the electronic money; and
the processor is configured to issue the coupon in response to the request for issuing the coupon and to output the gift details including data on the coupon.

4. The server according to claim 1, wherein:
the gift request includes information that restricts use of the electronic money; and
the processor is configured to, upon acquiring, from the second device, a payment request for the electronic money gifted to the second device, determine whether a use of the electronic money matches the information.

5. The server according to claim 1, wherein the processor is configured to:
upon acquiring a payment request for the electronic money from the second device, authenticate the payment request;
execute a payment process when the authentication is successful; and
output a payment completion notification to the first device and the second device.

6. The server according to claim 1, wherein the processor is configured to:
accept a payment request using one of a plurality of payment methods which are different from each other;
output the gift request to a third device that executes a corresponding payment method as the gifting process; and
upon acquiring a gift completion notification from the third device, output the gift details and the message to the second device.

7. The server according to claim 6, wherein the processor is configured to:
upon acquiring the payment request for the electronic money from the second device, authenticate the payment request;
output the payment request to the third device when the authentication is successful; and
upon acquiring a payment completion notification from the third device, output the payment completion notification to the first device and the second device.

8. A computer-readable medium storing a program causing a processor having hardware to:
upon acquiring from a first device a gift request for electronic money and a message for a second device, execute authentication the gift request;
execute a gifting process when the authentication is successful; and
output gift details and the message to the second device.

9. The computer-readable medium according to claim 8, wherein:
the gift request includes a deposit amount of the electronic money; and
the program causes the processor to deposit the deposit amount into an electronic money account associated with the second device.

10. The computer-readable medium according to claim 8, wherein:
the gift request includes a request for issuing a coupon of the electronic money; and
the program causes the processor to issue the coupon in response to the request for issuing the coupon and to output the gift details including data on the coupon.

11. The computer-readable medium according to claim 8, wherein:
the gift request includes information that restricts use of the electronic money; and
the program causes the processor to, upon acquiring from the second device a payment request for the electronic money gifted to the second device, determine whether a use of the electronic money matches the information.

12. The computer-readable medium according to claim 8, wherein the program causes the processor to:
upon acquiring a payment request for the electronic money from the second device, authenticate the payment request; and
execute a payment process when the authentication is successful; and
output a payment completion notification to the first device and the second device.

13. The computer-readable medium according to claim 8, wherein the program causes the processor to:
accept a payment request using one of a plurality of payment methods which are different from each other;
output the gift request to a third device that executes a corresponding payment method as the gifting process; and
upon acquiring a gift completion notification from the third device, output the gift details and the message to the second device.

14. The computer-readable medium according to claim 13, wherein the program causes the processor to:
upon acquiring the payment request for the electronic money from the second device, authenticate the payment request;
output the payment request to the third device when the authentication is successful; and
upon acquiring a payment completion notification from the third device, outputting the payment completion notification to the first device and the second device.

15. A system comprising:
a first device provided with a first processor having hardware;
a second device provided with a second processor having hardware; and
a server provided with a third processor having hardware, wherein:
the first processor is configured to output, to the server, a gift request for electronic money and a message for the second device; and
the third processor is configured to:
upon acquiring the gift request of the electronic money and the message, execute authentication the gift request;
execute a gifting process when the authentication is successful; and
output gift details and the message to the second device.

16. The system according to claim 15, wherein:
the gift request includes a deposit amount of the electronic money; and
the third processor is configured to deposit the deposit amount into an electronic money account associated with the second device.

17. The system according to claim 15, wherein:
the gift request includes a request for issuing a coupon of the electronic money; and
the third processor is configured to issue the coupon in response to the request for issuing the coupon and to output the gift details including data on the coupon.

18. The system according to claim 15, wherein:
the gift request includes information that restricts use of the electronic money; and
the third processor is configured to, upon acquiring a payment request for the electronic money gifted to the second device from the second device, determine whether a use of the electronic money matches the information.

19. The system according to claim 15, wherein:
the second processor is configured to output a payment request for the electronic money to the server; and
the third processor is configured to:
upon acquiring the payment request for the electronic money from the second device, authenticate the payment request;
execute a payment process when the authentication is successful; and
output a payment completion notification to the first device and the second device.

20. The system according to claim 15, further comprising:
a third device which is provided with a fourth processor having hardware, the third device being configured to execute a predetermined payment method, wherein:
the third processor is configured to accept a payment request using one of a plurality of payment methods which are different from each other, and output the gift request to the third device when a corresponding payment method is the payment method executed by the third device;
the fourth processor is configured to execute a gifting process in response to the gift request and to output a gift completion notification to the server; and
the third processer is configured to, upon acquiring the gift completion notification from the third device, output the gift details and the message to the second device.
